(19) United States
(12) Patent Application Publication
(10) Pub. No.: US 2009/0115158 A1
(43) Pub. Date: May 7, 2009

(54) Mobility trainer

(75) Inventor: Paul Kevin Lawrence, Rowlett, TX (US)

Correspondence Address: PAUL K. LAWRENCE, 9110 WESTFIELD DR., ROWLETT, TX, 75088, US

(73) Assignee: Paul Kevin Lawrence, Rowlett, TX (US)

(21) Appl. No.: 11/982,629

(22) Filed: Nov. 5, 2007

(51) Int. Cl. A61H 3/04

(52) U.S. Cl. 280/200; 135/67

(57) ABSTRACT

This is made of 1½″ metal pipe with a seating system. It is open where a physical therapist can easily watch the user's mobility functions. This has a circle top with a 26″ circumference. The Mobility Trainer has 4 vertical 1½″ pipes that attach on the top circle of 26″ circumference and to the bottom oval shape of 30″ circumference. It has a 23″ opening on the 26″ circumference circle top. This has 4 swivel wheels, the front having a total locking system and will hold 250 lbs. each. Each wheel has a circumference of 4″. It has a seating system that will hold up to 250 lbs., and unhooks to swing out of the way. The seating system hooks onto the top circle around the 23″ opening.

### FIELD OF THE INVENTION

The present invention relates to a physical therapist being able to help a patient safely, by the great advantage of closely monitoring the patient mobility skills and advisement to increase the patient skills. If during a therapy session the patient should get tired, they can sit down on the seat and the physical therapist can advise the therapy session further.

### SUMMARY OF THE INVENTION

The Mobility Trainer will be a very helpful tool for a physical therapist helping a patient to improve their mobility skills. The physical therapist will be able to monitor the patient as they demonstrate their mobility skills and make helpful suggestions to improve their skills as the patient is using the Mobility Trainer.

### THIS IS A BRIEF DESCRIPTION OF THE DRAWINGS

FIG. 1 shows a back view of the Mobility Trainer with a perspective enlarged plan view of a portion of the caster assembly of the present invention.

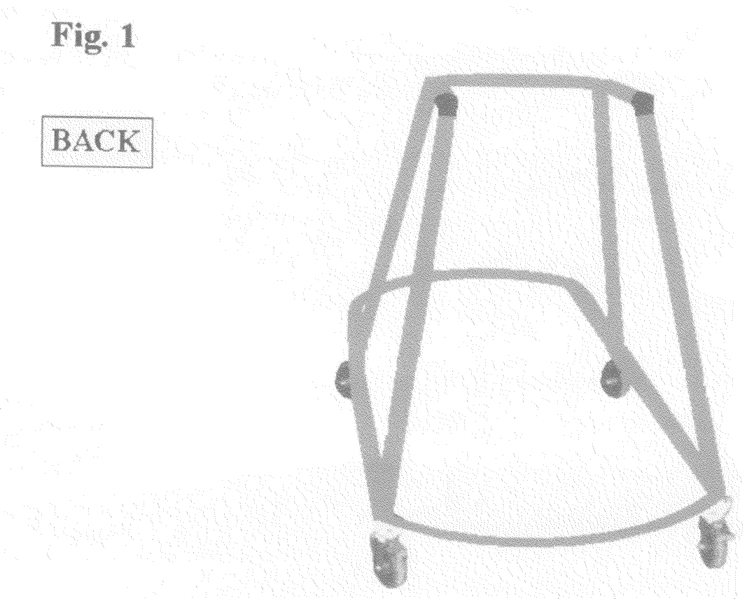

FIG. 2 is a front view of the device in accordance with FIG. 1.

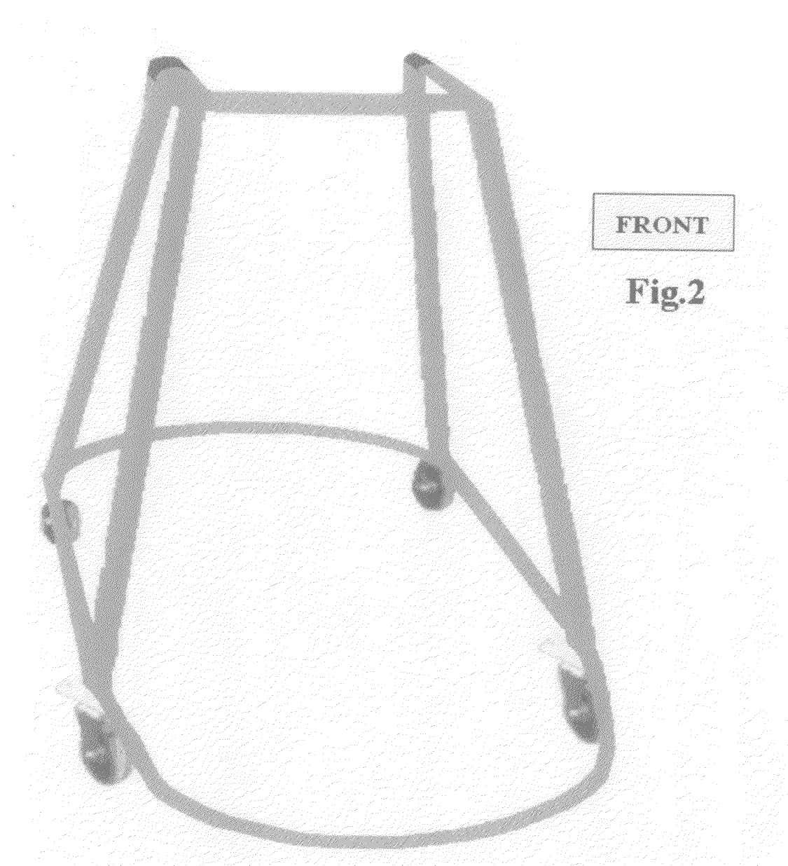

FIG. 3 is the left view of the device in accordance with FIG. 1.

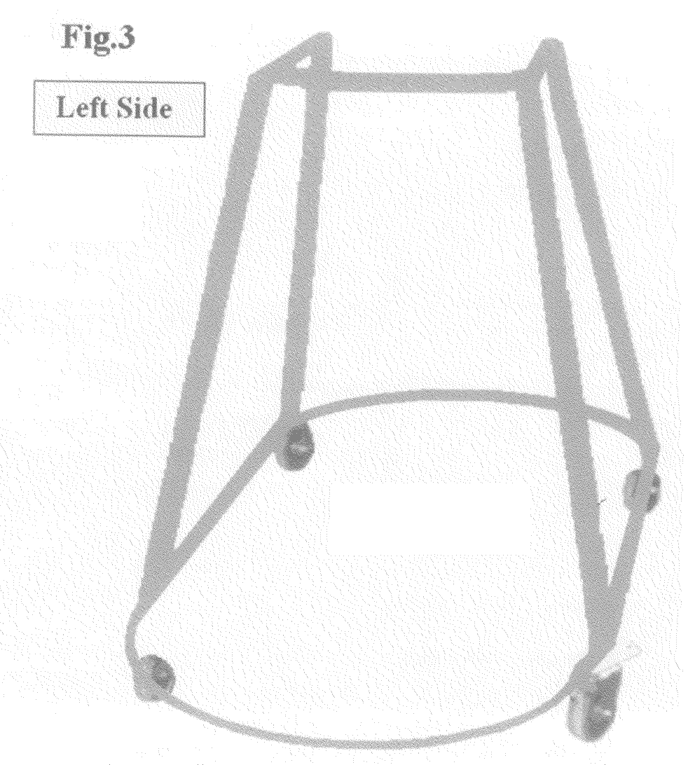

FIG. 4 is the right view of the device in accordance with FIG. 1.

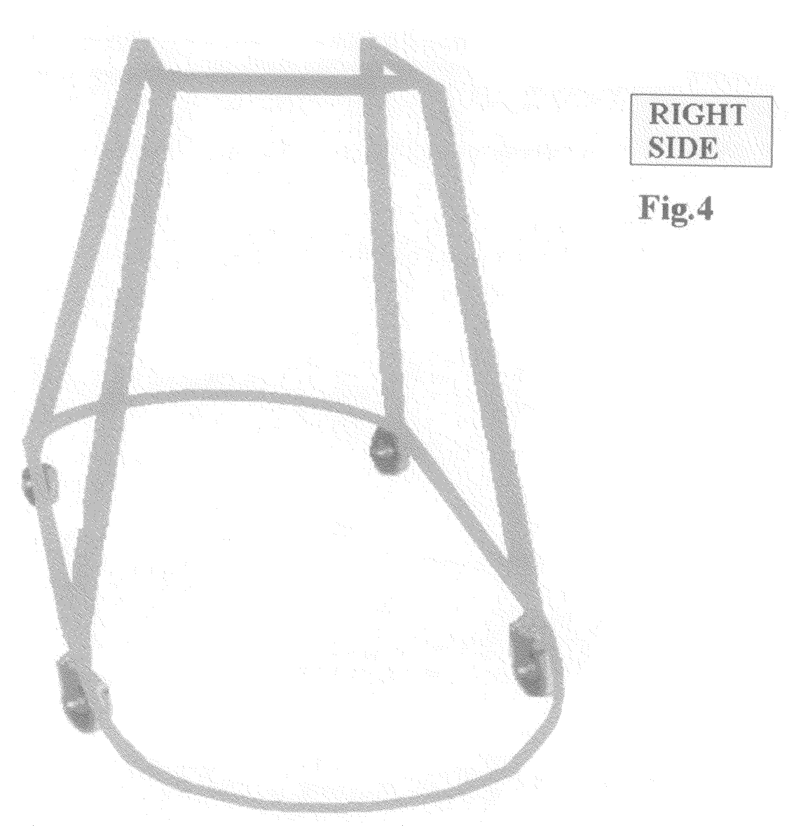

FIG. 5 is the top view of the device in accordance with FIG. 1.

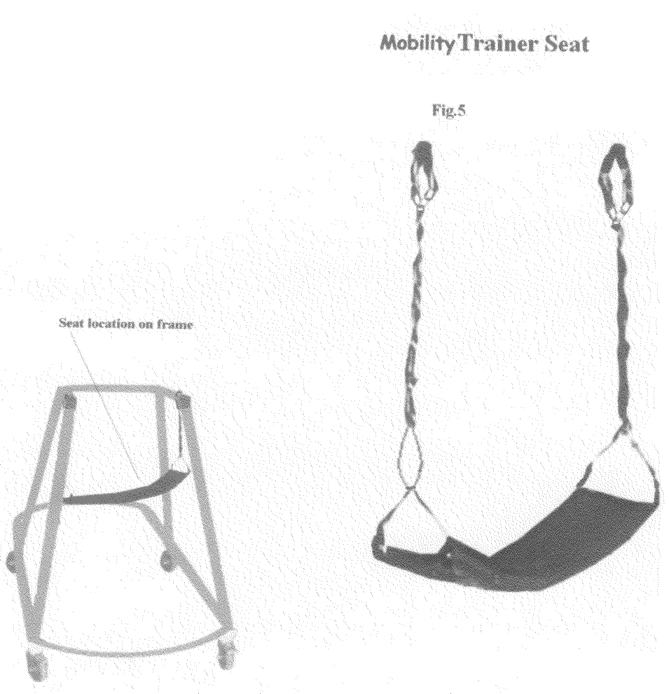

FIG. 6 shows a detail description of the seating system in accordance with FIG. 1 and the seat location on frame.

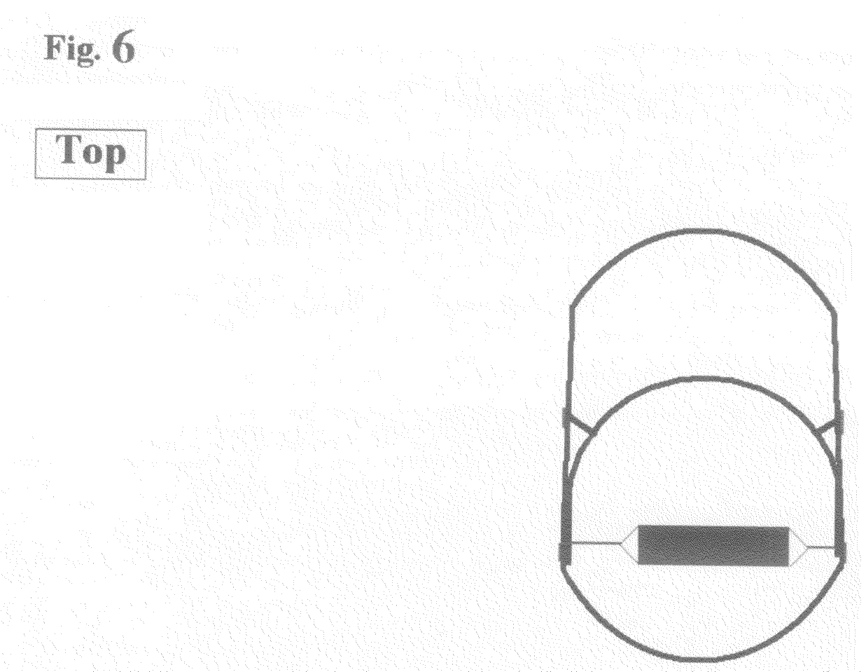

### DESCRIPTION OF THE PREFERRED EMBODIMENT

As to the manner of usage and operation of the invention it is preferred to be used on a level surface. A physical therapist would be able to monitor the patient's mobility skills at the present time and giving helpful advisement to increase the patient mobility skills.

### A DETAIL DESCRIPTION OF INVENTION

This is the detail description of the Mobility Trainer that has a height of 38″. The pipes (A, B, C & D) will be 6″ shorter of the 32″ & will be even 6″ shorter more of the 26″ tall.
1. There is a piece of 1.5″ Aluminum pipe 126″ long. With a 1.5″ hole 31.5″ from end & 31.5″ from center of the 1.5″ hole & 31.5″ from center of the 1.5″ hole. Leaving from center of hole 31.5″.
2. Use another piece of 1.5″ Aluminum pipe 59.5″ long. Roll the piece until it makes a 30″ circle. Weld a quick 90 to both ends and the 90 will point down_and at an angle, so that pipes (C & D) will fit to the quick 90. We will call this the top circle.
3. Using a third piece of 1.5″ Aluminum pipe 136.66″ long. Roll the piece until it makes a 33″ circle. But weld the ends of the 33″ circle. We will call this the bottom circle.
4. Pieces (A, B, C & D) 31.5″ pipes will be tack welded to the 33″ wide circle (bottom circle). (A & B) on front side and (C & D) on back side.
5. 26″ wide circle with a 23″ opening (top circle) will be put on to the pipes (A & B) & (C & D). The 31.5″ (A & B) long pipes will be tack welded to the 26″ wide circle with a 23″ opening.
6. Then put pipes to the 31.5″ long on to (A & B) & (C & D) pipes to the 33″ wide circle (bottom circle) and then tack weld both ends of the 31.5″ long pipes (A & B) & (C & D) to 26″ wide circle with a 23″ opening (top circle) and to the 33″ wide circle (bottom circle). After the top circle and the bottom circle have been tack welded to (A & B) & (C & D) pipes, weld over all the tack welds on (A & B) & (C & D) pipes.
7. A (3″×4″×¼″) piece of Aluminum wheel plate with a 5/16″ hole in each corner will be welded to the 33″ wide circle (bottom circle), in the center of pipes (A, B, C AND D).
8. A (1″×5.5″×⅛″) welded on to wheel plate and to the 33″ wide circle (bottom circle)
9. (¼″×½″) Aluminum bolt will be inserted into each inside, ¼″ holes on the (3″×4″×¼″) wheel
10. The top of (¼″×½″) bolt be welded to inside of wheel plate
11. Seat will be put on next.
12. All welds will be clean, so it will not oxidize
13. Attach all 4″ swivel casters, using two 5/16 Aluminum bolts on the outside with 4 lock nuts for inside & outside. A ⅜″ fender washer will be put next to the wheel and inside the wheel bracket. There will be 30 inch pounds of torque on the center bolt holding the wheel.

Mobility Trainer Seat

A. A piece of ⅛″ twisted swing chain in a plastic tubing 15.5″ length. A piece of a ½″ wide band of the plastic off the end exposing ¼″ of a link.

B. Continue 7″ from exposed link another piece will be cut (a 1″ wide band of the plastic) off, exposing ½ of a link.

C. A piece 7″ long twisted swing chain will be wrapped around the top circle, with long part on outside

D. Links will be hooked together with a ⅛″ quick chain link screw type

E. A cut of ½″ wide band of the plastic will be made at the end exposing ¼ of a link at the end of the 8.5″ piece of plastic covered swing chain. A ¼″ chain clasp will hook the (3″×1.5″) ends of chain together.

F. Using a 18.5″ length of twisted swing chain with plastic cover will be cut a ½″ wide band of the plastic off the end exposing ¼ of a link.

G. 7″ from exposed link a cut of 1″ wide band of the plastic is cut off, exposing ½ of a link.

H. piece 7″ long will be wrapped around top 1.5″ pipe

I. The links will be hooked together with a ⅛″ screw chain link

J. A ½″ wide band of the plastic will be cut off at the end exposing ¼ of a link at the end of the 11.5″ piece of plastic covered swing chain. A “Y” hook will go through the exposed link with hooks on outside. “Y” are (caromed or nickel) plated.

K. A 21″ piece of ⅛″ twisted swing chain with no plastic cover will be slipped into the molded tube on the front bottom of seat and a 21″ piece in the back bottom of seat. On other side of seat hook, the “Y” will be through the exposed link.

L. The seat is a molded plastic reinforced swing seat

What is claimed is:

1. The Mobility Trainer provides a tool to further the physical therapist's ability to a great advantage of closely monitoring the patient and giving helpful advisement to increase patient mobility, and, if during use the user gets tired, they can just sit in the seat and the physical therapist can advise the therapy session further, which will give the user a mental boost by seeing how far they have traveled under their own power, compared to the horizontal bars, and the unit can be stored safely and uses less floor space than a set of horizontal bars.
